(19) United States
(12) Patent Application Publication
(10) Pub. No.: US 2014/0145026 A1
(43) Pub. Date: May 29, 2014

(54) Unmanned Aerial Device

(71) Applicant: Hans Skjersaa, Bend, OR (US)

(72) Inventor: Hans Skjersaa, Bend, OR (US)

(21) Appl. No.: 13/687,155

(22) Filed: Nov. 28, 2012

(51) Int. Cl. B64D 47/08; F16F 15/04; B64C 25/02; B64D 27/02; B64C 39/02

(52) U.S. Cl. CPC B64D 47/08; B64D 27/02; B64C 39/02; B64C 25/02; F16F 15/04
USPC 244/54; 244/100 R

(57) ABSTRACT

Unmanned aerial device are disclosed herein which include a flight element comprising a central structural component configured to protect electronic circuitry, and structural beams, extending generally horizontally from opposing sides of the structural component, each beam being configured to contain electric wiring and a motor and to support a propeller. The device also includes a platform element, extending below the flight element, configured to support a video capturing device and a battery pack. In some implementations multiple vibration-dampening elements connect the flight element to the platform element to create a bi-deck vibration dampening system.

### BACKGROUND

Successfully capturing high quality aerial photography and video has traditionally required expensive and complicated systems. Improvements in micro circuitry and battery technology have allowed development of unmanned aerial vehicles. Small high definition cameras capable of being mounted on unmanned aerial vehicles can successfully capture high quality images and video. However, unwanted vibration can render images useless.

### SUMMARY

In one aspect, the invention features an unmanned aerial device including a flight element, comprising a central structural component configured to protect electronic circuitry, and structural beams, extending from the structural component, each beam being configured to contain electric wiring and a motor and to support a propeller. The aerial device also includes a platform element, extending below the flight element, which is configured to support a video device.

Some implementations may include one or more of the following features. The platform element may include an independent structural platform that is removably mounted on the structural component. For example, one or more vibration dampening elements may be mounted between the structural component and the independent structural platform to vibrationally isolate the platform element from the flight element.

The structural beams are disposed on opposing sides of the structural component in the horizontal plane, and may be removably mounted on the structural component. The central structural component may include an open framework box having a cover configured to enhance the strength of the box while minimizing weight. For example, in some cases the cover comprises an open frame having a generally X-shaped central member. The structural beams may comprise formed aluminum, and may be substantially U-shaped in cross-section.

In another aspect, the invention features an unmanned aerial device that includes a flight element configured to enable the device to fly a platform element configured to act as landing gear for the device and on which a video device may be mounted, and a vibration dampening element configured to join the flight element to the platform element while vibrationally isolating the flight element from the platform element.

Some implementations may include one or more of the following features. The vibration dampening element may include an elastomeric material, for example a synthetic viscoelastic polyurethane polymer.

The flight element may include one or more propellers, and the platform element may include a plurality of arms. At least some of the legs include a longitudinal bend or flange to enhance the strength of the arm. The platform element includes a removable camera mount. The flight element may include a central structural element, and the vibration dampening element may be positioned to interface with a perimeter surface of the central structural element and an opposing surface of the platform element. In some cases, two or more resilient elements are spaced around the perimeter of the structural element and positioned to interface with the upper surface of the central portion of the platform element.

### DESCRIPTION OF THE DRAWINGS

FIG. 1 is a perspective view of an assembled device according to one embodiment.

FIG. 2 is a top view of the device.

FIG. 3 is a perspective view of the frame of the device without the electrical and flight element components.

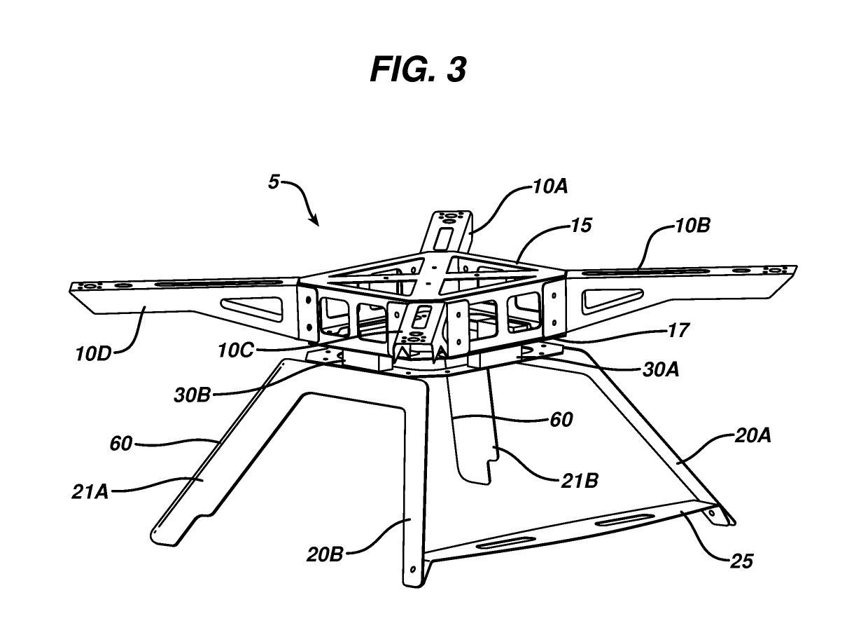

FIG. 4 is an exploded view of the frame.

### DETAILED DESCRIPTION

As discussed above, in preferred implementations the unmanned aerial device described herein includes a flight element comprising a central structural component configured to protect electronic circuitry, and structural beams, extending generally horizontally from opposing sides of the structural component, each beam being configured to contain electric wiring and a motor and to support a propeller. The device also includes a platform element, extending below the flight element, configured to support a video capturing device and a battery pack. Multiple vibration-dampening elements connect the flight element to the platform element to create a bi-deck vibration dampening system. The vibration-dampening elements substantially isolate the platform element from mechanical vibrations produced by the rotations of the propellers during flight operations enabling clean, crisp, blur-free image capture.

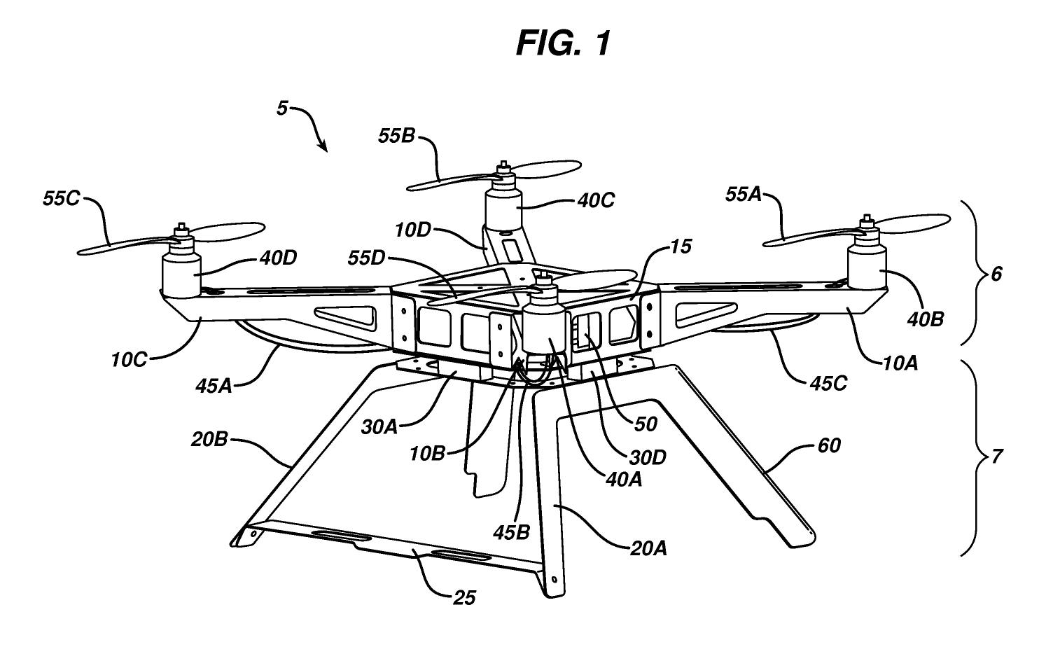

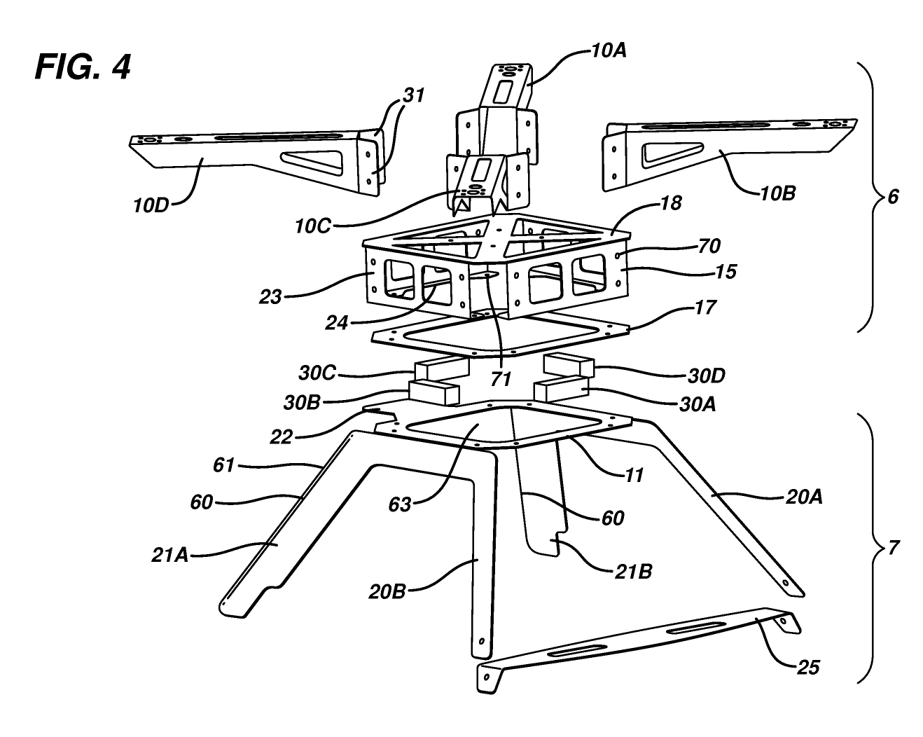

Referring to FIGS. 1 and 4, the unmanned aerial device 5 includes a flight component 6 that includes a central structural component 15, structural beams 10A-D, a central structural base 17 (FIG. 4), vibration-dampening elements 30A-D, and a platform component 7 that includes a battery mounting element 22, and landing arms 20A-B, to which a camera mounting element 25 is removably attached. The battery mounting element and camera mounting element are disposed on opposite sides of the frame so as to counter-balance one another.

The frame elements of the platform component and flight component are preferably formed by press-forming sheet aluminum alloy, for light weight and ease of manufacturing. Accordingly, the frame elements are generally formed of an aluminum alloy that is press-formable, e.g., aluminum 5052. Preferably, the frame elements are formed of sheet aluminum alloy that is 0.050 inches thick, but could range from 0.030 to 0.080.

The platform component 7 is removably attached to the flight component 6 by four vibration-dampening elements 30A-D. The vibration-dampening elements 30A-D can be attached to the opposed surfaces of the flight component and platform component (i.e., to the lower surface of the structural base 17 and the upper surface of the central portion 11 of the platform element (FIG. 4) by adhesive. For example, the vibration- dampening elements may be provided with a pressure-sensitive adhesive on the surfaces that will be adhered to the frame, or an adhesive such as a cyanoacrylate may be applied to the surfaces during assembly. Thus, removal of the platform component from the flight component, e.g., for repair or replacement, may require destruction of the vibration dampening elements, which can then be replaced after scraping off any residual material from the vibration dampening elements 30A-D from the frame surfaces.

The vibration dampening elements 30A-D may be formed of any material that will provide the desired dampening functionality. Suitable materials include elastomeric materials, for example thermoplastic elastomers and synthetic viscoelastic urethane polymers such as those commercially available under the trade name SORBOTHANE® polymer. The thickness of the elements may be, for example, from about 0.125″ to 1.0″, and is generally thick enough to provide sufficient vibration dampening while minimizing weight.

The flight component 6 further includes four propellers 55A-D, which are driven by propeller motors 40A-D. The propeller motors 40A-D are controlled by electronic controlling components 50 via wiring 45A-D. It is generally preferred that the propeller motors be configured on the upper surface of the distal ends of the structural beams 10A-D, and the wiring be run through the center of the structural beams, as shown. The electronic controlling components generally include, for example, a gyroscope, a receiver, a speed controller, and a transmitter, and may also include other optional components such as a wireless image transmitter. In one implementation, when fully assembled the flight component 6 measures 13.25 inches by 13.25 inches from the distal end of one structural beam to the next structural beam. This dimension can be, for example, from about 9 to 30 inches. Additionally, the flight component 6 measures 19.75 inches from the tip of one structural beam to the tip of the opposite corresponding structural beam. This dimension is preferably less than 22 inches, e.g. from 18 to 21 inches, but could range from 15 to 40 inches.

The central structural component of the flight component is designed to have high strength to protect the electronic controlling components, while being relatively lightweight. To achieve this balance of properties, the central structural component has an open structure to minimize weight, and design features that enhance strength.

Referring to FIG. 4, the central structural component includes a cover 18, four side walls 23, which are generally integrally formed with the cover, and four lower rim members 24 that extend perpendicularly from the lower edge of the side walls. The X-shaped configuration of the cover minimizes the amount of material used, while providing the central structural member with good racking strength. The side walls provide mounting points for the structural beams, and the geometry of the attachment of the structural beams to the side walls further contributes to the strength of the central structural component. The lower rim members 24 provide a mounting point for the central structural base 17, and enhance the strength of the side walls by providing an L-shaped beam structure. The central structural base 17 also contributes to the strength of the central structural component 15 by supporting the side walls and completing the rectangular prismatic structure of the central structural component 15. Preferably, the central structural component 15 is dimensioned to 5.375 inches long by 5.375 inches wide by 1.75 inches tall. The dimensions of the central structural component 15 could be greater so that the interior volume would be sufficient to contain additional componentry, or, could be smaller to minimize weight if less interior volume is required.

The central structural base 17 is configured to be removably attached to the central structural component 15 by screwing the base to the structural component. Preferably the holes 71 in the rim members 24 include a threaded insert, e.g., a Heli-Coil® insert or SPIRALOCK®, so that nuts are not needed and the screws will resist vibrational loosening.

The central structural base 17 encapsulates the electronic controlling components 50 (shown in FIG. 1) of the unmanned aerial device 5. Preferably, assembly of the frame components is completed prior to incorporating the electronic controlling components 50 and the flight components. In one embodiment, the electronic controlling components 50 are attached to the central structural base 17 by hook and loop fasteners configured with self-adhesive backing This configuration allows secure mounting for flight operations while enabling easily removal for repair or replacement. Alternatively, other attachment devices, e.g. cable ties, can be used to secure the electronic components 50 in the central structural base 17. In addition, the lower surface of the central structural base 17 serves as the attachment point for the vibration-dampening elements 30A-D. The central structural base 17 is formed so that a maximum amount of material is removed from the central portion while maintaining strength. The open area in the central structural base also allows the electrical controlling components 50 to be inserted from the bottom.

Referring to FIG. 4, the structural beams 10A-D are formed in an inverted “U” shape and with two mounting tabs 31 that are oriented to interface with the corners of the central structural base 17. The structural beams 10A-D are configured to be removably attached to the central structural base 17 by utilizing metal screws. Preferably, the structural beams 10A-B are dimensioned to measure 6.25 inches long, 1.125 inches wide and 1.5 inches tall. Near the mid section of each structural beam the height of the beams increase in height to 1.62 inches to allow for a more secure interaction with the central structural component 15. This tapered design also increases the strength of the structural beams 10A-D. Like the holes 71 discussed above, holes 70 in the side walls 23 preferably include a threaded insert. A maximum amount of material is removed from the structural beams 10A-D to minimize weight while maintaining strength. The inverted “U” shape of the structural beams 10A-D enhances strength while also offering protection for the electrical wiring that connect the motors 40A-D to the electrical control components 50.

Referring to FIG. 4, landing arms 21A and 21B will tend to be more susceptible to bending or breakage during landing because they are not supported by a connecting member as are the arms 20A and 20B. Thus, landing arms 21A and 21B are formed with a rolled edge 60 along the outer edge 61 of each landing arm to enhance their structural strength. Preferably, the platform element 7 is dimensioned to measure 5.125 inches tall and the dimensions of the footprint of the landing arms 20A, 20B, 21A, 21B when the device is resting on the ground measures 11.125 inches by 11.125 inches. The dimensions of the footprint could range from 4.0 inches squared to 30 inches squared.

Referring to FIG. 4, the shape of the central portion 11 of the platform element 7 corresponds to that of the central structural base 17 to allow the platform element to be attached to the flight element via the vibration dampening elements. The central portion 11 includes a large open area 63. This design allows for elimination of unnecessary material and weight without sacrificing strength for the platform element 7, and also allows easy access to the electronic components. The camera mounting element 25 is removably attached to both landing arms 20A and 20B by, for example, a nut, lock washer and bolt.

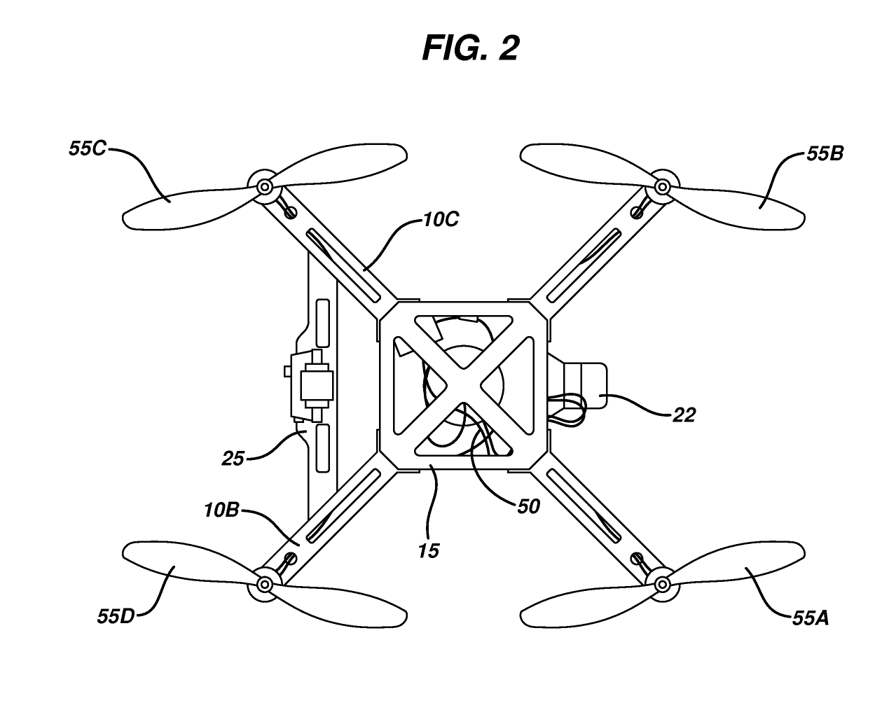

Referring to FIG. 2, the battery mount element 22 is configured preferably near the midpoint of the central portion 11 of the platform element 7 between the landing elements 21A and 21B. This configuration helps improve flight stability of the unmanned aerial device 5 by allowing in the weight of the battery to offset the weight of the camera that is configured to attach to the opposite side of the platform element 7 on the camera mounting element 25. The elongated shape of the battery mount element 22 allows the user to adjust the attachment position of the battery, inboard or outboard, to improve the aerial buoyancy of the unmanned aerial device 5. Preferably, the battery mount element 22 measures 2.25 inches by 2.25 inches but could be dimensioned differently to accommodate a variety of different types of battery packs.

In some implementations, the weatherproofing elements (not shown) are configured to fit around the central structural element 15 to protect the electronic controlling components 50 from atmospheric moisture, such as rain or snow. The weatherproofing elements can be, for example, clear plastic panels, e.g., of polycarbonate. In one implementation, the weatherproofing consists of a molded upper cover that has a top and four side walls, dimensioned to encapsulate the cover 18 and side walls 23, and a base dimensioned to cover the open area below the electrical controlling components 50.

Advantageously, the removability of many of the components of the device allows individual components to be easily removed and repaired or replaced if damaged during flight or landing. The modular nature of the components also allows the device to be easily transported and stored.

### Other Embodiments

A number of embodiments have been described. Nevertheless, it will be understood that various modifications may be made without departing from the spirit and scope of the disclosure.

Although four vibration dampening elements are shown in FIG. 4, adjustments could be made to the number of these elements utilized in the design in accordance with application requirements. For example, two vibration dampening elements may be used, in which case they would be positioned on opposite sides of the device, or a single, thinner, vibration dampening ring element could be provided that would extend around the entire perimeter of the interface between the flight element and the platform element. In addition, other embodiments could feature alternative vibration-dampening materials, instead of elastomers, to connect the flight element to the platform element, such as foam or other resilient materials.

Other embodiments could feature variations to the shape of the structural beams. For example, shape variations could include L-shape, circular, oval or something similar.

Although the use of an aluminum alloy is utilized for the preferred embodiment of the frame of the device, other embodiments could feature alternative materials in entirety or for certain aspects. For instance, alternative materials could be composites, such as carbon fiber or similar, plastics or other metal alloys.

The devices may also include various other optional components, such as lighting on the structural beams and/or landing arms.

Other embodiments could feature an alternative mode of connecting the different components of the device, such as the manner in which the structural beams are attached to the central structural component 11 or the camera mounting plate is attached to the landing gear arms. Moreover, if desired some of the components that are removable in the embodiment described above could be permanently attached or integrally formed.

Other embodiments could feature central structural components dimensioned in different prismatic shapes, e.g. a hexagon or an octagon.

Although four structural beams are featured in the preferred embodiment, other embodiments could feature additional members, e.g. six or eight structural members. The additional members would allow the device to be configured with additional propellers and motors enabling increased lift capabilities.

Other embodiments could feature a camera mount configured to be independently manipulated by a second operator. This alternate configuration could allow the camera to be angled independently of flight operations.

Accordingly, other embodiments are within the scope of the following claims.

What is claimed is:

1. An unmanned aerial device comprising:
a flight element, comprising a central structural component configured to protect electronic circuitry, and structural beams, extending from the structural component, each beam being configured to contain electric wiring and a motor and to support a propeller, and
a platform element, extending below the flight element, configured to support a video device.

2. The unmanned aerial device of claim 1 wherein the platform element comprises an independent structural platform that is removably mounted on the structural component.

3. The unmanned aerial device of claim 2 further comprising one or more vibration dampening elements mounted between the structural component and the independent structural platform to vibrationally isolate the platform element from the flight element.

4. The unmanned aerial device of claim 1 wherein the structural beams are disposed on opposing sides of the structural component in the horizontal plane.

5. The unmanned aerial device of claim 1 wherein the structural beams are removably mounted on the structural component.

6. The unmanned aerial device of claim 1 wherein the central structural component comprises an open framework box having a cover configured to enhance the strength of the box while minimizing weight.

7. The unmanned aerial device of claim 6 wherein the cover comprises an open frame having a generally X-shaped central member.

8. The unmanned aerial device of claim 1 wherein the structural beams comprise formed aluminum alloy.

9. The unmanned aerial device of claim 1 wherein the structural beams are substantially U-shaped in cross-section.

10. The unmanned aerial device of claim 1 wherein weatherproofing elements are mounted on the central structural element to substantially isolate the electrical components from atmospheric moisture.

11. An unmanned aerial device comprising:
a flight element configured to enable the device to fly;
a platform element configured to act as landing gear for the device and on which a video device may be mounted; and
a vibration dampening element configured to join the flight element to the platform element while vibrationally isolating the flight element from the platform element.

12. The unmanned aerial device of claim 10 wherein the vibration dampening element comprises an elastomeric material.

13. The unmanned aerial device of claim 11 wherein the elastomeric material comprises a synthetic viscoelastic polyurethane polymer.

14. The unmanned aerial device of claim 10 wherein the flight element includes one or more propellers.

15. The unmanned aerial device of claim 10 wherein the platform element includes a plurality of arms.

16. The unmanned aerial device of claim 14 wherein at least some of the legs include a longitudinal bend or flange to enhance the strength of the arm.

17. The unmanned aerial device of claim 10 wherein the platform element includes a removable camera mount.

18. The unmanned aerial device of claim 10 wherein the flight element includes a central structural element, and the vibration dampening element is positioned to interface with a perimeter surface of the central structural element and an opposing surface of the platform element.

19. The unmanned aerial device of claim 17 wherein two or more resilient elements are spaced around the perimeter of the structural element and positioned to interface with the upper surface of the central portion of the platform element.

20. The unmanned aerial device of claim 17 wherein weatherproofing elements are mounted on the central structural element to substantially isolate the electrical components from atmospheric moisture.
